(19) United States
(12) Patent Application Publication
(10) Pub. No.: US 2022/0034012 A1
(43) Pub. Date: Feb. 3, 2022

(54) NONWOVEN-FABRIC STRUCTURE AND MANUFACTURING METHOD THEREFOR

(71) Applicant: TOYOBO CO., LTD., Osaka-shi, Osaka (JP)

(72) Inventors: Shigeki Tanaka, Osaka-shi, Osaka (JP); Yukinari Okuyama, Otsu-shi, Shiga (JP); Hideo Yoshida, Otsu-shi, Shiga (JP)

(73) Assignee: TOYOBO CO., LTD., Osaka-shi, Osaka (JP)

(21) Appl. No.: 17/278,746

(22) PCT Filed: Sep. 20, 2019
(86) PCT No.: PCT/JP2019/037019

§ 371 Date: Mar. 23, 2021

(30) Foreign Application Priority Data
Sep. 25, 2018 (JP) 2018-178696

(51) Int. Cl. D06C 15/06; D04H 3/018; D04H 3/147

(52) U.S. Cl. CPC D06C 15/06; D04H 3/147; D04H 3/018

(57) ABSTRACT

A nonwoven fabric structure according to the present invention is a nonwoven fabric structure comprising a long-fiber nonwoven fabric as a main constituent, wherein the nonwoven fabric structure has a basis weight of 250 to 2000 g/m², a Frazier permeability of 0 to 20 cc/cm²·s, and an apparent density of 0.5 to 1.3 g/cm³, and therefore has excellent shaping properties and excellent mechanical strength properties.

### TECHNICAL FIELD

The present invention relates to a nonwoven fabric structure comprising a long-fiber nonwoven fabric as a main constituent material and having excellent shaping properties and excellent mechanical strength properties. The nonwoven fabric structure having excellent shaping properties and mechanical strength properties is suitably used in industrial materials applications, construction materials applications, automobile applications, and so on. In particular, it can be suitably used for lightweight shaped bodies having excellent post-shaping rigidity (such as an undercover and a dash silencer for automobiles), because it is easily shaped into the irregular shape of those molds, capable of achieving sound-absorbing performance and cushioning performance, and lightweight. Thus, it can contribute to automobile weight reduction and eventually to energy saving.

### BACKGROUND ART

Conventionally known nonwoven fabrics that have excellent shaping properties are mainly made of short fibers and have a high content of heat-adhesive fibers. Hence, they have problems regarding heat resistance and cost. Moreover, nonwoven fabrics having excellent shaping properties have a poor rigidity in general and require an increased basis weight. Nonwoven fabrics having a high mechanical strength (such as a high tensile strength and a high tear strength) have a high degree of fiber entanglement and therefore have poor shaping properties (poor elongation while heated). To solve these problems and obtain a nonwoven fabric having excellent shaping properties and excellent mechanical strength properties, the below-described methods were proposed.

PTL 1 discloses a nonwoven fabric having excellent elongation and shaping properties despite its low basis weight and low thickness, as an alternative for a high-basis-weight bulky nonwoven fabric formed by needle punching of a spunbonded long-fiber nonwoven fabric. According to this disclosure, however, it is difficult to obtain a nonwoven fabric having excellent mechanical strength properties. Moreover, this disclosure may require a long preheating time for preventing delamination between layers of the nonwoven fabric.

Each of PTLs 2 and 3 proposes a method of producing a dense, semi-finished automobile equipment, which is produced by forming three-dimensional fiber entanglement by needle punching of a web of a composite fiber that consists of a core component (polyethylene terephthalate) and a sheath component (a copolymerized polyester of ethylene glycol, adipic acid, terephthalic acid, and isophthalic acid, etc.). It is disclosed that this method has widened the heating temperature range that is adopted at the time of heating and compression molding, but no specific description is provided on rigidity. Moreover, this method requires a special component, and therefore has an impaired cost advantage compared to other methods using a general-purpose resin. Further, this method may have a problem in terms of difficulty in bonding with resins such as polypropylene which are generally used in automobiles.

A short-fiber nonwoven fabric comprising a sheath-core-type composite fiber and/or a heat-adhesive fiber may have good shaping properties, but the fiber in this nonwoven fabric has crimps and is thereby susceptible to deformation, which leads to a difficulty in enhancing the mechanical strength of the nonwoven fabric. This translates into necessity of adding a certain amount or more of a heat-adhesive component to the constituent fiber of this nonwoven fabric, but this component would compromise heat resistance. An alternative way of giving an excellent mechanical strength to the above-mentioned short-fiber nonwoven fabric is to increase the basis weight to a very high value.

A thermo-moldable short-fiber nonwoven fabric is used in sound absorbing material applications, but the use of a thermo-moldable short-fiber nonwoven fabric for the above-described applications is not preferred because the excellent cushioning performance of this nonwoven fabric would be compromised by the addition of a heat-adhesive fiber. Although it is still possible to preserve the cushioning performance by decreasing the packing density of the nonwoven fabric, this would cause a decrease in mechanical strength.

As described above, a nonwoven fabric structure having excellent shaping properties and excellent mechanical strength properties has not yet been proposed.

### CITATION LIST

### Patent Literature

PTL 1: Japanese Patent Laying-Open No. 3-241054
PTL 2: Japanese Patent No. 631841
PTL 3: Japanese Patent Laying-Open No. 2018-9256

### SUMMARY OF INVENTION

### Technical Problem

The present invention has been devised aiming at solving the above-described problems, and an object of the present invention is to provide a nonwoven fabric structure comprising a long-fiber nonwoven fabric as a main constituent material and having excellent shaping properties and excellent mechanical strength properties, as well as a method of producing the same.

### Solution to Problem

The inventors of the present invention have conducted intensive research aiming at solving the above problems and, as a result, completed the present invention, which is as follows: (1) A nonwoven fabric structure comprising a long-fiber nonwoven fabric as a main constituent, wherein the nonwoven fabric structure has a basis weight of 250 to 2000 g/m², a Frazier permeability of 0 to 20 cc/cm²·s, and an apparent density of 0.5 to 1.3 g/cm³; (2) The nonwoven fabric structure according to (1), wherein the nonwoven fabric structure comprises a stack of two or more nonwoven fabrics and has a surface smooth ratio of 40% or more; (3) The nonwoven fabric structure according to (1) or (2), wherein the nonwoven fabric structure comprises a nonwoven fabric consisting of a composite fiber, near at least one surface; (4) A nonwoven fabric structure obtainable by disposing a tape-shaped sheet structure obtained by embedding a bundle of inorganic fibers in a thermo-moldable resin, on at least one surface and/or near at least one surface of the nonwoven fabric structure according to any one of (1) to (3), and then performing shaping by press processing; (5) A three-dimensional-structure molded body obtainable by subjecting the nonwoven fabric structure according to any one of (1) to (4) to press processing; (6) A method of producing a nonwoven fabric structure, characterized by comprising stacking at least two or more long-fiber nonwoven fabrics having a basis weight of 200 g/cm² or more, performing mechanical entanglement, and subsequently performing press processing under conditions involving a heating temperature of 140 to 255° C. and a pressing pressure of 0.1 to 5 MPa.

### Advantageous Effects of Invention

The present invention provides a nonwoven fabric structure having excellent shaping properties and excellent mechanical strength properties.

### BRIEF DESCRIPTION OF DRAWINGS

FIG. 1 is a view describing a method of measurement using a three-point bending test.

### DESCRIPTION OF EMBODIMENTS

A detailed description of the present invention will be given below. The basis weight of the nonwoven fabric structure of the present invention may be selected according to the mechanical strength properties required of a final product, but it is from 250 to 2000 g/m², preferably from 500 to 1750 g/md, more preferably from 1000 to 1500 g/m². When the basis weight is less than 250 g/m², lightweight is achieved but mechanical strength properties (rigidity, in particular) are poor. When the basis weight is more than 2000 g/m², the difference from a conventional nonwoven fabric structure is small.

The nonwoven fabric structure according to the present invention comprises a long-fiber nonwoven fabric as a main constituent. The mass fraction of the long-fiber nonwoven fabric as a main constituent relative to the nonwoven fabric structure is preferably 25 mass % or more, more preferably 30 mass % or more, further preferably 50 mass % or more. When the mass fraction of the long-fiber nonwoven fabric is less than 25 mass %, the rigidity-enhancing action of the long fiber is less likely to be exhibited. In other words, a crimp-free long fiber in the nonwoven fabric is often present with few bends and no looseness or warpage, and, as a result, the strength of each fiber can directly contribute to the mechanical strength properties of the nonwoven fabric. This makes it possible to obtain a highly-rigid nonwoven fabric. The majority of constituent fibers of the long-fiber nonwoven fabric are oriented not in a thickness direction but in a two-dimensional in-plane direction, potentially making it easy to enhance mechanical strength properties such as rigidity and initial modulus.

The long-fiber nonwoven fabric (as a main constituent of the nonwoven fabric structure according to the present invention) may be used in the form of a monolayer, but preferably, it is used in the form of a stack of two or more layers in the nonwoven fabric structure. When the long-fiber nonwoven fabric in the form of a monolayer is shaped and used, the long-fiber nonwoven fabric needs to have many of its fibers oriented in a thickness direction for preventing delamination within the layer. When the long-fiber nonwoven fabric is used in the form of a monolayer, the fibers may have an increased number of points of constraint, which may compromise shaping properties. To prevent this, a plurality of long-fiber nonwoven fabrics may be subjected to preliminary loose fiber entanglement before stacked and formed into a single layer by mechanical entanglement and/or the like. This procedure makes it easy to achieve good shaping properties while attaining a moderate level of fiber constraint and thereby preventing delamination. The smaller the basis weight per monolayer is, the more enhanced the mechanical strength properties (such as rigidity) can be by the influence caused by orienting the fibers in an in-plane direction.

As a resin that constitutes the constituent long-fiber nonwoven fabric, a polyester-based resin, a polyolefin-based resin, and a polyamide-based resin are preferable, and, among these, a polyester-based resin and a polyolefin-based resin (which are inexpensive thermoplastic resins for general purpose applications) are particularly preferable. Examples of the polyester-based resin can include homopolyesters such as polybutylene terephthalate (PBT), polyethylene terephthalate (PET), polybutylene naphthalate (PBN), polyethylene naphthalate (PEN), polycyclohexane dimethyl terephthalate (PCHT), and polytrimethylene terephthalate (PTT, and copolymerized polyesters derived from copolymerization of these. Examples of the polyolefin-based resin can include polyethylene (PE) and polypropylene (PP). In addition, additives that are typically used, such as a coating, a pigment, a matting agent, an antistatic agent, a flame retardant, and reinforcement particles may also be contained. Further, as long as the objects of the present invention are not impaired, a small amount of other polymers such as a polyamide-based resin and an olefin-based resin may also be mixed in. Aiming at enhancing adhesion between fibers, use of a polyester-based resin, more specifically, a copolymerized polyester containing 4 to 12 mol % isophthalic acid as an acid component and/or a copolymerized polyester containing 10 to 60 mol % neopentyl glycol ethylene oxide as a glycol component also constitutes a preferable embodiment.

The method of producing the long-fiber nonwoven fabric for use as a constituent is preferably spunbonding, since this method allows fibers of the long-fiber nonwoven fabric to be oriented in an in-plane direction (two-dimensional in-plane direction) and thereby makes it easy to enhance mechanical strength properties such as rigidity. As a constituent fiber of the long-fiber nonwoven fabric, a sheath-core-type composite fiber and/or a side-by-side-type composite fiber is preferably used. Particularly preferable are combinations of PP/PET, copolymerized PET/PET, and PBT/PET. Also preferable is to dispose a long-fiber nonwoven fabric comprising the above composite fiber near at least one surface of the nonwoven fabric structure. The expression “near (at least one) surface” herein means that, when the thickness of the nonwoven fabric structure is defined as 100%, the long-fiber nonwoven fabric comprising a composite fiber is present in the region of 0 to 25% away from the (at least one) surface. In the configuration in which a film is affixed to a surface of the long-fiber nonwoven fabric or in which resin impregnation is carried out, the sheath component is preferably made of a material that is highly adhesive with the film or with the resin material used for impregnation. As a nonwoven fabric for use to be integrated into a surface of the nonwoven fabric structure, a long-fiber nonwoven fabric with a high modulus of fiber elasticity is particularly preferable for the purpose of enhancing mechanical strength properties (such as rigidity) of the nonwoven fabric structure.

The fineness of a constituent fiber of the nonwoven fabric structure is not particularly limited, and is preferably from 1 to 10 dtex, more preferably from 2.5 to 7 dtex, from the viewpoint of productivity and mechanical strength properties.

Aiming at performing shaping with high efficiency, treating a surface of a constituent fiber of the nonwoven fabric structure and making it low fiction constitutes a preferable configuration as well. A preferable configuration of the low-friction treatment is to treat with an oil. Examples of the oil includes a modified-polyester-based resin containing a polyester-polyether block copolymer, as well as an oil that essentially contains a silicone-based polymer which is a modified silicone (such as an amino-modified organopolysiloxane and/or an epoxy-modified organopolysiloxane) in combination with a hardening agent that is reactive with the modified silicone. The method for applying the oil to a fiber surface is not particularly limited, and spraying, dipping, and/or the like may be adopted.

As a constituent fiber of the nonwoven fabric structure, a fiber with a low crystallization ratio is also preferably used. A nonwoven fabric comprising a fiber with a low crystallization ratio has good shaping properties, and is easy to increase its fiber-to-fiber adhesion by performing heat treatment. When spunbonding is adopted as the method of producing the nonwoven fabric, the resin may be made into fibers at a spinning rate that is lower than a condition where the resin would be oriented and crystallized to form stable filaments, and then formed into a sheet. When a polyester-based resin is used, the spinning rate is preferably 3,500 m/min or less, more preferably from 2.000 to 3,300 m/min. The spinning rate needs to be adjusted as appropriate according to the resin used. When short fibers are used, undrawn staple fibers available from multiple manufacturers may be used. Also preferable is to dispose a nonwoven fabric comprising the fiber with a low crystallization ratio near at least one surface of the nonwoven fabric structure.

The nonwoven fabric structure according to the present invention is produced by hot pressing, and has a Frazier permeability of 0 to 20 cc/cm²·s, preferably of 0.01 to 15 cc/cm²·s. When the Frazier permeability is more than 20 cc/cm²·s, adhesion between constituent fibers of the nonwoven fabric structure is weak, which may make it difficult to achieve a high rigidity.

The nonwoven fabric structure according to the present invention is dense, having an apparent density of 0.5 to 1.3 g/cm³. The apparent density is preferably from 0.6 to 1.2 g/cm³, more preferably from 0.8 to 1.1 g/cm³. When the apparent density is less than 0.5 g/cm³, it is difficult to achieve a high rigidity. When it is more than 1.3 g/cm³, shaping properties tend to be impaired, the nonwoven fabric structure tends to experience brittle fracture and/or buckling, and the heat treatment duration in hot pressing performed for increasing the apparent density tends to be long, leading to an increase in working cost.

After mechanical entanglement and subsequent hot-pressing, the nonwoven fabric structure according to the present invention preferably has a surface smooth ratio of at least 40% or more. When the surface smooth ratio is 40% or more, a fender liner and an undercover, for example, that comprises the nonwoven fabric structure can reduce accretion and entrance of adherents (such as soil) and snow. When the surface smooth ratio is 40% or more, a high energy loss occurs upon passing of a sound wave and thereby a high sound-absorbing rate can be achieved. When the surface smooth ratio is less than 40%, it is difficult to achieve a sufficient flexural rigidity.

A preferable configuration of stacking nonwoven fabrics constituting the nonwoven fabric structure is to stack two, or more, nonwoven fabric layers, with a breakdown of a long-fiber nonwoven fabric consisting of mono-component fibers and a nonwoven fabric consisting of sheath-core-type fibers, and also preferable is to stack three nonwoven fabric layers, with a breakdown of a long-fiber nonwoven fabric consisting of mono-component fibers sandwiched between nonwoven fabrics each consisting of sheath-core-type fibers.

An embodiment of the nonwoven fabric structure according to the present invention is as follows: for example, a long-fiber nonwoven fabric consisting of mono-component fibers is sandwiched between nonwoven fabrics each consisting of sheath-core-type fibers to form a stack, and subsequently water punching and/or needle punching is carried out to make a water jet and/or a needle penetrated thereinto from the side of the nonwoven fabric consisting of sheath-core-type fibers so as to form entanglement. In a long-fiber nonwoven fabric, fibers do not move very freely within the nonwoven fabric and therefore problems such as delamination tend to occur even after needle punching. Thus, the number of penetrations and the needle depth for needle punching are selected as appropriate according to the type of the needles, the desired mechanical strength properties, and the basis weight of the layers. In the configuration in which a nonwoven fabric consisting of sheath-core-type fibers is used as at least one surface and a long-fiber nonwoven fabric consisting of mono-component fibers is used as a middle layer, only a single round of hot molding can form a composite structure that has a highly-rigid surface layer part as well as an inner layer consisting of a flexible fiber structure, and, as a result, the flexible inner layer can reduce tapping sounds while the highly-rigid surface layer can reduce wear and the like.

In another preferable configuration, the nonwoven fabric structure according to the present invention is produced by disposing a tape-shaped sheet structure obtained by embedding a bundle of inorganic fibers in a thermo-moldable resin (for example, QuickForm (registered trademark) manufactured by and available from Toyobo Co., Ltd., which is a tape consisting of PP and glass fibers), on one surface and/or near one surface of the nonwoven fabric during production thereof, and then performing pressing. Performing shaping causes the tape-shaped structure to melt and form a single-piece part, and thereby the resulting automobile fender cover and undercover, for example, comprising the part can prevent problems such as wear and cracks from being caused by a small rock and the like flown out from beneath a tire or elsewhere.

Next, hot pressing performed during production of the nonwoven fabric structure according to the present invention will be described. This may be press molding of a veneer sheet, or may be passing between hot metal press rolls adopted to long-piece production (such as a calendering setup manufactured by Yuri Roll Co., Ltd., for example), or may be use of a high-temperature metal belt press. Hot pressing is preferably carried out under conditions involving a heating temperature of 140 to 255° C. and a pressing pressure of 0.1 to 5 MPa. Hot pressing may be carried out just once or multiple times to produce the nonwoven fabric structure. Also, after the nonwoven fabric structure is prepared, three-dimensional molding may be carried out with the use of a press machine and/or by cold-press molding to form a three-dimensional-structure molded body.

### EXAMPLES

In the following, Examples of the present invention are described. The present invention is not limited to these Examples. In the Examples and Comparative Examples, values of physical properties were measured according to the methods described below.

<Basis Weight> A test piece (nonwoven fabric) was cut into a 20-cm square, and its mass was measured, from which a mass per 1 m² was calculated and defined as the basis weight (g/m²).

<Apparent Density> In accordance with JIS L1913 (2010) 6.1.1, the thickness of the test piece (nonwoven fabric) was measured under a load of 20 g/cm². The above-measured basis weight was divided by the thickness to obtain the apparent density.

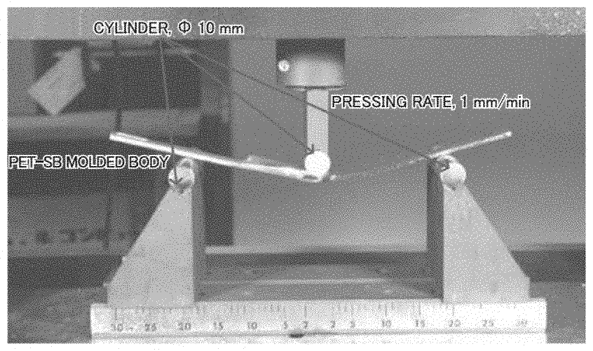

Apparent density=A/B (g/cm³), A: basis weight (g/m²), B: thickness (cm)

<Surface Smooth Ratio> A scanning micrograph of a surface of the test piece was taken under a magnification of 300 times, and a 10-time enlarged photocopy of the micrograph was made, followed by measurement of the mass of the micrograph. Then, non-smooth portions were cut off with a box cutter, followed by measurement of the mass of the remainder. The ratio of the mass of the remainder to the mass of the original was calculated. Instead of cutting, smooth portions may be marked with a color marker, followed by image analysis for measuring the area and determining the same ratio. The measured values are greatly varied, and therefore the average of three locations is shown (with a unit of 5%).

<Delamination> The nonwoven fabric structure was cut out into a size of 5-cm width and 30-cm length. The resultant was bent with a hand in a longitudinal direction to form an angle of around 90 degrees, and this was repeated 20 times, followed by visual examination of delamination.

<Frazier Permeability> Measurement was carried out in accordance with JIS L1096 (2010) 8.26.1A Method (the Frajour method). When the fiber density of the middle part of the nonwoven fabric structure is small, air may flow onto a surface of a fixing part such as a gasket to give a value higher than the actual value. To prevent this, it may be necessary to seal the edges of the sample with melted paraffin to avoid penetration.

<Flexural Rigidity> In accordance with JIS K7017 (1999), a three-point bending test (see FIG. 1) was carried out. A test piece strip to be evaluated having a width of 22 mm and a length of 6 cm was prepared, and subjected to measurement with a support width of 16 times the thickness of the test piece strip and an indenter radius of 5 mm, at the following rate: (half the thickness of the test piece strip) per minute.

(Example 1) Four pieces of needle-punched mechanically-entangled long-fiber nonwoven fabrics consisting of polyethylene terephthalate long fibers (fineness, 5.0 dtex) and having a basis weight of 250 g/m² (VOLANS (registered trademark) manufactured by Toyobo Co., Ltd.) were stacked, followed by needle punching with the use of Organ FPD220 (40 SM) at 38 penetrations/cm² and a needle depth of 10 mm to obtain a nonwoven-fabric stack. The resulting nonwoven-fabric stack had an apparent density of 0.09 g/cm³. Subsequently, the resulting nonwoven-fabric stack was pressed with the use of a metal belt press (manufactured by KBK Steel Products Co., Ltd.) at a heating temperature of 190° C. and a pressing pressure of 0.1 MPa. The resulting nonwoven fabric structure had an apparent density of 0.76 g/cm³. Various physical properties of the nonwoven fabric structure are shown in Table 1. Further, a surface of the nonwoven fabric structure was subjected to far-infrared heat treatment at 250° C. for 45 seconds, followed by cold-press shaping with the use of a cylinder (m 50 mm; depth, 50 mm), and, as a result, good shaping properties were obtained.

(Example 2) Two pieces of needle-punched mechanically-entangled long-fiber nonwoven fabrics consisting of polyethylene terephthalate long fibers (fineness, 5.0 dtex) and having a basis weight of 250 g/m² (VOLANS (registered trademark) manufactured by Toyobo Co., Ltd.) were stacked. To each side of the resultant, a short-fiber nonwoven fabric having a basis weight of 250 g/m² and consisting of sheath-core-type composite fibers (sheath component, polypropylene: core component, polyethylene terephthalate) (mass ratio of polypropylene component, 30%; fineness, 6.6 dtex) was disposed, so as to sandwich the stack of two long-fiber nonwoven fabrics, followed by needle punching with the use of Organ FPD220 (40 SM) at 38 penetrations/cm² and a needle depth of 10 mm to obtain a nonwoven-fabric stack. The resulting nonwoven-fabric stack had an apparent density of 0.23 g/cm³. Subsequently, the resulting nonwoven-fabric stack was pressed with the use of a metal belt press (manufactured by KBK Steel Products Co., Ltd.) at a heating temperature of 190° C. and a pressing pressure of 0.1 MPa. The resulting nonwoven fabric structure had an apparent density of 0.74 g/cm³. Various physical properties of the nonwoven fabric structure are shown in Table 1. Further, a surface of the nonwoven fabric structure was subjected to far-infrared heat treatment at 220° C. for 45 seconds, followed by cold-press shaping with the use of a cylinder (050 mm; depth, 50 mm), and, as a result, good shaping properties were obtained.

(Example 3) Two pieces of needle-punched mechanically-entangled long-fiber nonwoven fabrics consisting of polyethylene terephthalate long fibers (fineness, 5.0 dtex) and having a basis weight of 250 g/m² (VOLANS (registered trademark) manufactured by Toyobo Co., Ltd.) were stacked. To each side of the resultant, a long-fiber nonwoven fabric having a basis weight of 250 g/nm and consisting of sheath-core-type composite fibers (sheath component, polypropylene; core component, polyethylene terephthalate) (mass ratio of polypropylene component, 30%; fineness, 5.0 dtex) was disposed, so as to sandwich the stack of two long-fiber nonwoven fabrics, followed by needle punching with the use of Organ FPD220 (40 SM) at 38 penetrations/cm² and a needle depth of 10 mm to obtain a nonwoven-fabric stack. The resulting nonwoven-fabric stack had an apparent density of 0.23 g/cm³. Subsequently, the resulting nonwoven-fabric stack was pressed with the use of a metal belt press (manufactured by KBK Steel Products Co., Ltd.) at a heating temperature of 190° C. and a pressing pressure of 0.1 MPa. The resulting nonwoven fabric structure had an apparent density of 0.90 g/cm³. Various physical properties of the nonwoven fabric structure are shown in Table 1. Further, a surface of the nonwoven fabric structure was subjected to far-infrared heat treatment at 220° C. for 45 seconds, followed by cold-press shaping with the use of a cylinder (050 mm; depth, 50 mm), and, as a result, good shaping properties were obtained.

(Comparative Example 1) A needle-punched mechanically-entangled long-fiber nonwoven fabric consisting of polyethylene terephthalate long fibers (fineness, 5.0 dtex) and having a basis weight of 500 g/m² (VOLANS (registered trademark) manufactured by Toyobo Co., Ltd.) was further subjected to needle punching with the use of Organ FPD220 (40 SM) at 38 penetrations/cm² and a needle depth of 10 mm to obtain a nonwoven fabric with a high apparent density. The resulting long-fiber nonwoven fabric had an apparent density of 0.19 g/cm³. Subsequently, the nonwoven fabric was pressed with the use of a metal belt press (manufactured by KBK Steel Products Co., Ltd.) at a heating temperature of 190° C. and a pressing pressure of 0.1 MPa. The resulting nonwoven fabric had an apparent density of 0.40 g/cm³. The nonwoven fabric structure were napped. Various physical properties of the nonwoven fabric structure are shown in Table 1. Further, a surface of the nonwoven fabric structure was subjected to far-infrared heat treatment at 250° C. for 45 seconds, followed by cold-press shaping with the use of a cylinder (m 50 mm; depth, 50 mm), and, as a result, good shaping properties were obtained.

(Comparative Example 2) Ten layers of heat-adhesive long-fiber nonwoven fabrics consisting of polyethylene terephthalate long fibers (fineness, 3.0 dtex) and having a basis weight of 100 g/m² (ECULE (registered trademark) manufactured by Toyobo Co., Ltd.) were stacked, followed by needle punching with the use of Organ FPD220 (40 SM) at 38 penetrations/cm² and a needle depth of 10 mm to obtain a nonwoven-fabric stack. The resulting nonwoven-fabric stack had an apparent density of 0.22 g/cm³. Subsequently, the resulting nonwoven-fabric stack was pressed with the use of a metal belt press (manufactured by KBK Steel Products Co., Ltd.) at a heating temperature of 190° C. and a pressing pressure of 0.1 MPa. The resulting nonwoven fabric structure had an apparent density of 0.66 g/cm³. Various physical properties of the nonwoven fabric structure are shown in Table 1. Further, a surface of the nonwoven fabric structure was subjected to far-infrared heat treatment at 250° C. for 45 seconds, followed by cold-press shaping with the use of a cylinder (Φ50 mm; depth, 50 mm), and, as a result, delamination occurred.

(Comparative Example 3) Four layers of needle-punched mechanically-entangled long-fiber nonwoven fabrics consisting of polyethylene terephthalate long fibers (fineness, 5.0 dtex) and having a basis weight of 250 g/m² (VOLANS (registered trademark) manufactured by Toyobo Co., Ltd.) were stacked, followed by another needle punching with the use of Organ FPD220 (40 SM) at 38 penetrations/cm² and a needle depth of 10 mm to obtain a nonwoven-fabric stack. The resulting nonwoven-fabric stack had an apparent density of 0.22 g/cm³. Subsequently, the resulting nonwoven-fabric stack was pressed with the use of a plane roll press at a heating temperature of 190° C. and a pressure of 80 kN/cm. The resulting nonwoven fabric structure had an apparent density of 0.66 g/cm³. The resulting nonwoven fabric structure was slightly warped. In addition, when it was bent, delamination occurred near the center. Various physical properties of the nonwoven fabric structure are shown in Table 1. Further, a surface of the nonwoven fabric structure was subjected to far-infrared heat treatment at 250° C. for 45 seconds, followed by cold-press shaping with the use of a cylinder (Φ50 mm; depth, 50 mm), and, as a result, wrinkles were formed.

(Conventional Example) A general-purpose PP resin (MFR20) was thermo-shaped at a heating temperature of 200° C. to prepare a 1.8-mm flat plate. The resultant was a rigid body, and therefore almost no sound-absorbing properties were observed. Various physical properties of the flat plate are shown in Table 1. Further, a surface of the flat plate was subjected to far-infrared heat treatment at 250° C. for 45 seconds, followed by cold-press shaping with the use of a cylinder (Φ50 mm; depth, 50 mm), and, as a result, good shaping properties were obtained.

TABLE 1

| | | | | | Comparative | Comparative | Comparative | Conventional |
|---|---|---|---|---|---|---|---|---|
| Item | Unit | Example 1 | Example 2 | Example 3 | Example 1 | Example 2 | Example 3 | Example |
| Basis Weight | g/m² | 1008 | 1005 | 1001 | 500 | 1032 | 1012 | 980 |
| Appearance-Warpage | — | No | No | No | Napped | No | Edge | No |
| | | Abnormality | Abnormality | Abnormality | | Abnormality | Warped | Abnormality |
| Apparent Density | g/cm³ | 0.76 | 0.74 | 0.90 | 0.40 | 0.66 | 0.66 | 0.90 |
| Frazier Permeability | cc/cm² · s | 2 | 0 | 0 | 22 | 1 | 5 | 0 |
| Surface Smooth Ratio | % | 65 | 90 | 80 | 30 | 45 | 35 | 100 |
| Flexural Rigidity | Mpa | 55 | 61 | 68 | 12 | 41 | 8 | 43 |
| Delamination | — | None | None | None | Delamination | Delamination | Delamination | None |
| | | | | | (Slightly) | | (Slightly) | |
| Press-Shaping Properties | — | Good | Good | Good | Good | Delamination | Wrinkles | Good |

As described above, the present invention makes it possible to provide a nonwoven fabric structure comprising a long-fiber nonwoven fabric as a main constituent and having good shaping properties and excellent flexural rigidity, as well as a method of producing the same.

### INDUSTRIAL APPLICABILITY

The nonwoven fabric structure obtainable according to the present invention can be effectively utilized as a lightweight building material and industrial material, an automobile structure such as an undercover, a fender liner, a hood silencer, and a tonneau board, a base material, a sound absorbing material, and the like, and can make a significant contribution to the industry.

1. A nonwoven fabric structure comprising a long-fiber nonwoven fabric as a main constituent, the nonwoven fabric structure having a basis weight of 250 to 2000 g/m², a Frazier permeability of 0 to 20 cc/cm²·s, and an apparent density of 0.5 to 1.3 g/cm³.

2. The nonwoven fabric structure according to claim 1, wherein the nonwoven fabric structure comprises a stack of two or more nonwoven fabrics and has a surface smooth ratio of 40% or more.

3. The nonwoven fabric structure according to claim 1, wherein the nonwoven fabric structure comprises a nonwoven fabric consisting of a composite fiber, near at least one surface.

4. A nonwoven fabric structure obtainable by disposing a tape-shaped sheet structure obtained by embedding a bundle of inorganic fibers in a thermo-moldable resin, on at least one surface and/or near at least one surface of the nonwoven fabric structure according to claim 1, and then performing shaping by press processing.

5. A three-dimensional-structure molded body obtainable by subjecting the nonwoven fabric structure according to claim 1 to press processing.

6. A method of producing a nonwoven fabric structure, characterized by comprising stacking at least two or more long-fiber nonwoven fabrics having a basis weight of 200 g/cm² or more, performing mechanical entanglement, and subsequently performing press processing under conditions involving a heating temperature of 140 to 255° C. and a pressing pressure of 0.1 to 5 MPa.
